(19) United States
(12) Patent Application Publication
(10) Pub. No.: US 2001/0045991 A1
(43) Pub. Date: Nov. 29, 2001

(54) DRIVE MECHANISM FOR SURVEILLANCE CAMERA PAN AND TILT

(76) Inventors: PIET C.J. VAN RENS, ASTEN (NL); RAOF FATTAH-SUMO, EINDHOVEN (NL); RICHARD R. WRIGHT, REINHOLDS, PA (US)

Correspondence Address: CORPORATE PATENT COUNSEL, US PHILIPS CORP, 580 WHITE PLAINS ROAD, TARRYTOWN, NY, 10591

(21) Appl. No.: 08/966,599

(22) Filed: Nov. 10, 1997

Related U.S. Application Data
(63) Continuation-in-part of application No. 08/798,197, filed on Dec. 9, 1996, now abandoned.

(51) Int. Cl. H04N 5/232

(52) U.S. Cl. 348/373; 348/211

(57) ABSTRACT

This invention discloses a camera pan and tilt mechanism wherein both the pan and the tilt motors are affixed to the stationary structure. Conventional systems are designed with the tilt motor affixed to a structure which is moved by the pan motor. Displacing the tilt motor from the structure which is moved by the pan motor allows the pan motor and the enclosing envelope to be smaller, and the design of the tilt motor and movable structure to be less complex. The overall result is a less massive, less costly, more reliable design, with faster dynamic performance.

### BACKGROUND OF THE INVENTION

1. Field of the Invention

This invention generally relates to camera mounting equipment, and means for controlling the direction of camera view. The principles embodied in this invention are equally applicable to any device which provides for movement through at least two axes, nominally perpendicular to each other.

2. Discussion of the Related Art

U.S. Pat. Nos. 4,654,703, 5,111,288, and 5,394,209 depict pan and tilt mechanisms for orienting a camera in a desired direction. In each of these references, reflective of the art, the desired orientation is achieved utilizing two motors, each of which are capable of rotating the camera through one axis. Nominally, rotation through the vertical axis is referred to as tilt, while rotation through the horizontal axis is referred to as pan. In the prior art, one of the motors, hereinafter the “movable motor” is located on the mechanism which is moved by the other motor, hereinafter the “stationary motor”. Typically, the panning mechanism consists of a tray which is rotated in the horizontal direction, and upon this tray is the tilt motor affixed to the camera. The panning motor is the stationary motor, and the tilting motor is the movable motor. Control signals can be sent to each motor, independently or dependently, to move the pan plate, or to tilt the camera, or both.

This arrangement, one motor affixed to a mount which the other motor moves, has a number of limitations and deficiencies:

The movable motor has mass and volume. The stationary motor and the movable structure must be made larger and heavier to move and contain this movable motor.

The movable motor requires power and control signals. Providing such signals to the movable structure without impacting the movability of the structure typically requires the use of a slipring assembly. Additional connections to the movable motor, for feedback control or other uses, requires additional contacts through the slipring assembly as well. In a slipring assembly, the movable structure contains wiping arms and the stationary structure contains matching concentric conductor rings for transferring the signals to the movable structure. Slipring assemblies are costly, and are more prone to failure than a direct connection to the motor.

The design of the movable motor and movable structure supporting this motor often requires custom designed devices or manufacturing techniques to minimize the mass and volume of the movable unit, which increases costs. Also, the design of the movable structure often requires that it remain balanced, independent of the orientation of the camera. Such balancing is made significantly more difficult by the presence of the tilt motor, particularly since the camera mechanism should be at the center of rotation, forcing the mass of the tilt motor to be off center.

The mass and volume constraints on the movable structure impose limitations on the design of the movable motor. One design approach may, for example, have advantages with regard to torque or control resolution, but be infeasible because of mass and volume constraints.

Each of these limitations and deficiencies can be overcome by displacing the movable motor from the movable structure, but such a displacement must still allow for the movement of the device on the movable structure in a direction perpendicular to the movement of the structure.

### SUMMARY OF THE INVENTION

Essentially, the invention describes a pan and tilt design concept which allows both the pan motor and the tilt motor to be mounted on a stationary structure, while still providing for unrestricted rotation through both axes.

Two concentric, independent, pulleys are arranged along the axis of rotation perpendicular to the stationary plane. The two motors, mounted on this stationary plane, are each coupled to these pulleys. The first pulley is directly coupled to the movable platform for rotation about that axis, while the second pulley is coupled to the camera mount through a 90 degree transformation. The transformation can be accomplished by common techniques such as a perpendicular gear arrangement, worm drives, idler wheels, etc. In the preferred embodiment, the transformation is achieved by a tensioned filament fixed to a drive and driven pulley over two idlers. The drive pulley is directly coupled to this second pulley, and the driven pulley is directly coupled to the camera mount.

Through the use of this invention, the mass and volume of the “movable” motor, now a second “stationary” motor, is removed from the movable structure. This allows the first stationary motor to be smaller, the movable structure and its housing to be smaller, and the design of the movable structure to be simpler. It also allows all power and control signals to be directly connected to the motor, eliminating a costly slipring assembly, and significantly improving the reliability of the unit. Because the stationary structure has fewer design limitations, such as mass and volume, alternative motor technologies can be employed more readily.

Although the invention is presented in the context of a pan and zoom mechanism for a camera, the advantages provided by this invention are applicable to other configurations requiring directional control about two, or more, axes. Likewise, although the invention is presented for two perpendicular axes, and hence the 90 degree transformation means, it is equally applicable for other axes orientations. The advantages offered by displacing the mass of the motor from the movable structure will be readily apparent to one skilled in the art, and are not meant to be bound by the advantages presented herein.

### BRIEF DESCRIPTION OF THE DRAWINGS

FIG. 1 is a drawing of the preferred embodiment of the pan-tilt mechanism utilizing two stationary motors.

FIG. 2 is a drawing of an alternate embodiment.

### DETAILED DESCRIPTION OF THE PREFERRED EMBODIMENTS OF THE INVENTION

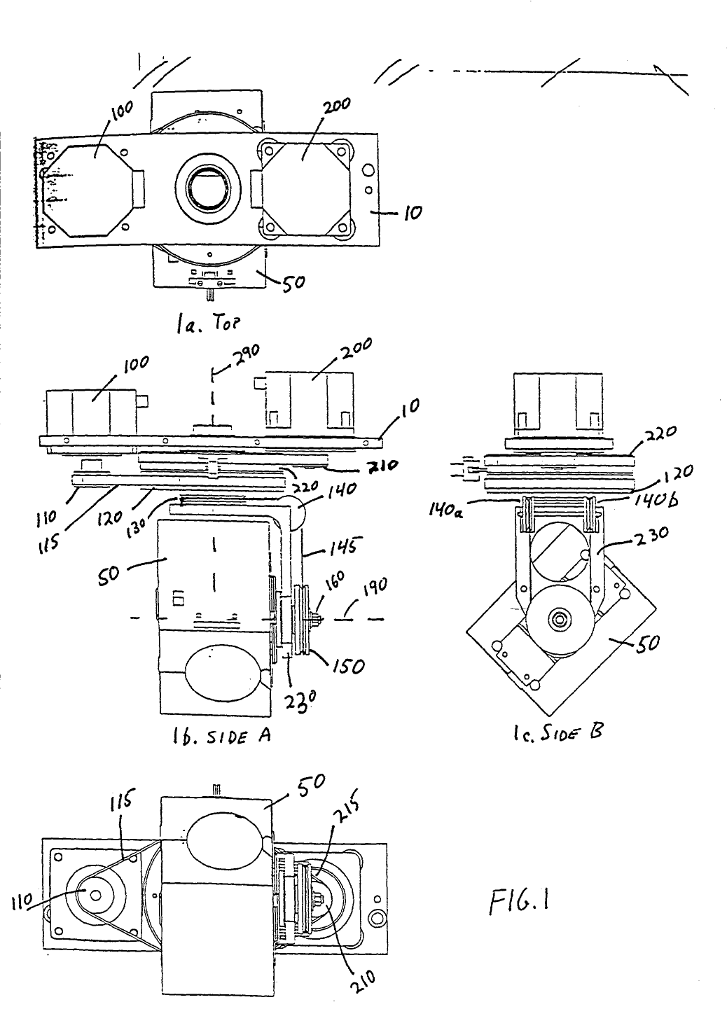

FIG. 1 shows a pan and zoom assembly in accordance with this invention. Two motors, the pan motor 200 and the tilt motor 100 are mounted on a stationary plate 10. This stationary plate is designed to be affixed to a ceiling structure or such (not shown) in the area to be monitored by the camera 50.

Pan motor 200 drives a pulley 210, which is coupled by a filament 215 to a driven pan pulley 220. The pan pulley 220 is directly coupled to a movable structure 230. The pan motor 200 is driven by pan control signals (not shown) to control the orientation of the camera 50 about the pan axis 290. Driving the pan motor 200 causes a rotation of pulley 210, which causes a rotation of the pan pulley 220 and the movable structure 230 about the pan axis 290. Although shown as a pulley arrangement, alternative methods could be employed, consistent with this invention, to rotate the movable structure 230 about the pan axis 290.

Tilt motor 100 drives a pulley 110, which is coupled by a filament 115 to a driven tilt pulley 120. The tilt pulley 120 is directly coupled to a drive pulley 130. The drive pulley 130 drives a driven pulley 150 by the filament 145, through a 90 degree change of direction at idler wheels 140a and 140b. The driven pulley 150 is directly coupled to the camera 50, by means of an axle 160 which passes through the movable structure 230. The coupling of the camera 50 and the pulley 150 through the movable structure 230 affixes the camera to the movable structure, but allows it to rotate on the axle 160 about the tilt axis 190. The tilt motor 100 is driven by tilt control signals (not shown) to control the orientation of the camera 50 about the tilt-axis 190. Driving the tilt motor 100 causes a rotation of pulley 110, which causes a rotation of the tilt pulley 120 and the drive pulley 130, which causes a rotation of the driven pulley 150 and the camera 50 about the tilt axis 190. Although shown as a pulley arrangement, alternative methods could be employed, consistent with this invention, to rotate the camera about the tilt axis 190 by transforming the tilt drive forces through 90 degrees relative to the pan drive forces.

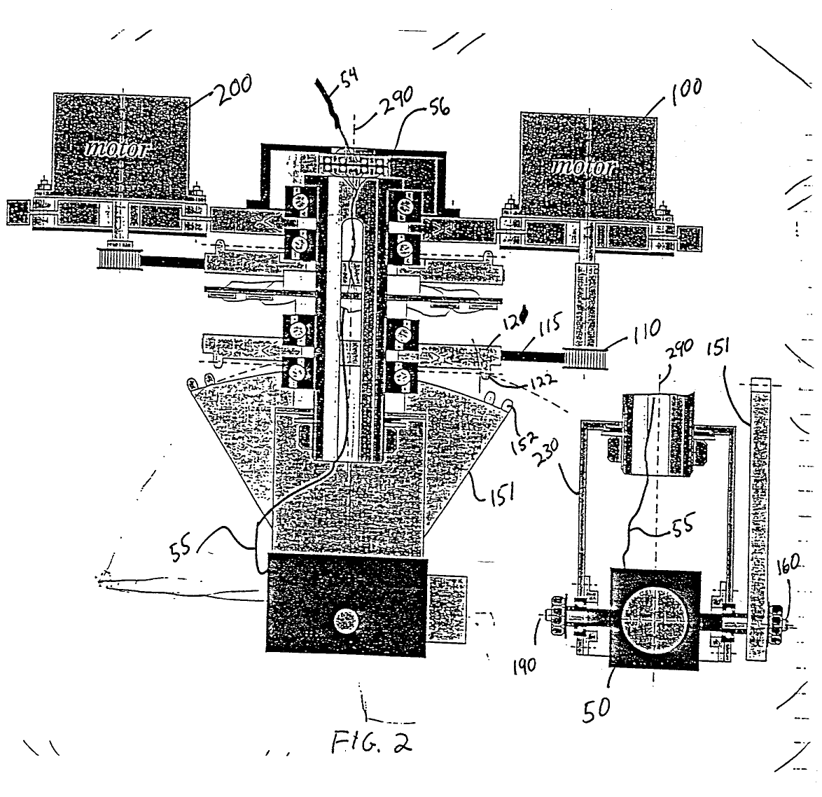

Although the movable structure 130 is shown as an L shaped bracket, it might be desirable to employ a U shaped bracket to mount the camera by two supports, both about the tilt axis 190, as shown in FIG. 2. This, and other modifications to provide support and/or balance will be apparent to one versed in the art.

FIG. 2 shows an alternate means for performing the 90 degree transformation of tilt drive forces. Tilt motor 100 is coupled to a pulley 121 by a filament 115. Pulley 121 contains perimeter protrusions 122. These protrusions are designed to couple to the teeth 152 of a gear element 151. Driving the tilt motor 100 drives the pulley 110 which drives the pulley 121. The rotation of pulley 121 causes the gear 151 to rotate by the engagement of the protrusions 122 and the teeth 152. The rotation of the pulley 121 about the pan axis 290 causes gear 151 to rotate about the tilt axis 190. Gear 151 is directly coupled, via axle 160, to the camera 50, through the movable structure 230 as discussed above. Gear 151 is shown as a wedge, which will limit the extent of the tilt angle of the camera. As would be apparent to one skilled in the art, gear 151 could be circular, thereby providing a full 360 degree rotation about the tilt axis 190.

Shown in FIG. 2 is a coupling cable 55, which carries the video signal from the camera, and power and control signals, such as zoom control, to the camera. These signals are conveyed by cable 54 through slipring assembly 56. Note that no tilt control or power signals need be conveyed through the slipring assembly. Techniques exist and are well known in the art for the transmission of video and control signals by wireless means and for battery powered cameras. By employing such techniques, cable 55 can be eliminated, thereby eliminating the need for a slipring assembly.

Also note that size of the motors are shown to be approximately equal. This is a result of the fact that each are driving approximately the same mass. Each of the motors can be optimally designed to satisfy the dynamic performance requirements, and neither are encumbered with the mass and inertia of the other. The overall result is smaller motors and faster dynamic performance because the movable element is smaller and lighter.

Further optimizations can be realized by noting that a mechanical advantage can be realized by the arragement of the motor drive pulley 110 and the driven pulley 120. The design of such mechanical advantage techniques would be dependent upon the mass driven and the dynamic performance required of the specific application, and are common to one versed in the art. The proper sizing of these pulleys could eliminate the need for gearboxes typically employed on the movable structure to multiply the torque and resolution of the movable motor.

Placing both motors on the stationary plate also allows for ancillary design optimizations. For example, to minimize the number of signals conveyed through the slip ring, a printed circuit board containing a portion of the control and feedback electronics is often placed adjacent to the movable motor on the movable structure. Similar electronics are also provided for the stationary motor. By placing both motors on the stationary plate, one printed circuit board, with potentially fewer parts, can be located on the stationary plate to control both motors. Likewise, the placement of feedback devices, such as optical sensors used in homing sequences for stepper motors, can be easily placed about the now stationary motor.

The design of similar motors and similar drive for both the pan and the tilt rotation mechanisms also provides for the opportunity for reduced design, manufacturing, and purchasing costs, by employing common parts throughout.

The removal of the mass of the motor from the movable platform significantly reduces the design complexity of symetric structures, such as shown in FIG. 2, thereby reducing the costs of ancillary items such as anti-vibration mounts and other noise reduction elements. And, the housing for this smaller movable structure can be minimized, a particular advantage in areas requiring non-obtrusive surveillance.

Although presented in the context of a mechanism for the rotational control of a camera, the use of this invention is not limited to this application. For example, this invention could form a part of a mechanism for providing two dimensional lateral movement, wherein the rotated item of this invention is itself a wheel, a pulley, a gear, or other such device for driving or controlling this movement.

The foregoing merely illustrates the principles of the invention. It will thus be appreciated that those skilled in the art will be able to devise various arrangements which, although not explicitly described or shown herein, embody the principles of the invention and are thus within its spirit and scope.

What is claimed is:

1. A device for rotating an item about two or more axes, comprising:
a first motor,
first means for rotating the item about a first axis,
a second motor,
second means for rotating the item about a second axis,
wherein said first motor is coupled to said first rotating means,
said second motor is coupled to said second rotating means, and
said first and second motors are fixedly attached relative to each other.

2. A device as in claim 1, wherein
said first axis and said second axis are approximately perpendicular to each other.

3. A device for rotating an item about two or more axes, comprising:
a stationary structure,
a movable structure,
a first rotating means having a first axis of rotation, and affixed to the stationary structure and to the movable structure, so as to allow the movable structure to rotate relative to said stationary structure about said first axis of rotation,
a second rotating means having a second axis of rotation, and affixed to the movable structure and to the said item, so as to allow the said item to rotate relative to said movable structure about said second axis of rotation,
said first rotating means being operatively coupled to a first motor,
said second rotating means being operatively coupled to a second motor, characterized in that said first and second motors are fixedly attached to said stationary structure only.

4. A device as in claim 3, wherein
said first axis and said second axis are approximately perpendicular to each other.

5. A device as in claim 3, wherein said operative coupling between said second rotating means and said second motor comprises:
a third rotating means having said first axis of rotation,
said third rotating means affixed to said stationary structure, and
said third rotating means being operatively coupled to said second motor and operatively coupled to said second rotating means.

6. A device as in claim 5, wherein:
said third rotating means comprises a drive pulley,
said second rotating means comprises a driven pulley,
said operative coupling between said second and third rotating means comprises a filament operatively engaging said drive and driven pulleys.

7. A device as in claim 5, wherein:
said second rotating means comprises a gear,
said third rotating means comprises means for operatively engaging said gear.

8. A camera steering device to rotate a camera about a pan axis and about a tilt axis, comprising:
a pan motor,
a tilt motor,
a stationary structure,
a movable structure,
a first means for rotating said movable structure relative to said stationary structure about said pan axis, in dependence upon the operation of said pan motor,
a second means for rotating said camera relative to said movable structure about said tilt axis, in dependence upon the operation of said tilt motor,
characterized in that said pan and tilt motors are fixedly attached to said stationary structure only.

9. A camera steering structure as in claim 8, further comprising:
a third rotating means about said pan axis,
said second and third rotating means being operatively coupled to each other, and
said third rotating means being operatively coupled to said tilt motor, thereby providing the rotation of said camera about said tilt axis in dependence upon the operation of said tilt motor.
